(19) United States
(12) Patent Application Publication
(10) Pub. No.: US 2019/0351541 A1
(43) Pub. Date: Nov. 21, 2019

(54) ALIGNMENT SCREW

(71) Applicant: Alvin Vanus Green, Charlotte, NC (US)

(72) Inventor: Alvin Vanus Green, Charlotte, NC (US)

(21) Appl. No.: 16/206,077

(22) Filed: Nov. 30, 2018

Related U.S. Application Data
(60) Provisional application No. 62/672,752, filed on May 17, 2018.

(51) Int. Cl. B25H 7/04

(52) U.S. Cl. CPC B25H 7/045

(57) ABSTRACT

An alignment screw. The alignment screw includes a body having a cylinder shape with a first end opposite a second end. The first end includes a male threaded portion. The second end includes a marking tip configured to mark a surface when the marking tip is pushed against the surface.

### CROSS-REFERENCE TO RELATED APPLICATION

This application claims the benefit of priority of U.S. provisional application No. 62/672,752, filed May 17, 2018, the contents of which are herein incorporated by reference.

### BACKGROUND OF THE INVENTION

The present invention relates to an alignment screw and, more particularly, to an alignment screw with a marking tip.

Installing a microwave requires measuring between cabinets and the back splash of a kitchen. Homeowners or professionals often incorrectly measure and drill holes in the wrong locations. The homeowner or professionals may then have to re-measure and drill new holes.

As can be seen, there is a need for a tool that marks an exact location needed for the above-mentioned holes.

### SUMMARY OF THE INVENTION

In one aspect of the present invention, an alignment screw comprises: a body having a cylinder shape with a first end opposite a second end, wherein the first end comprises a male threaded portion, and the second end comprises a marking tip configured to mark a surface when the marking tip is pushed against the surface.

In another aspect of the present invention, a method of providing alignment marks comprises steps of: providing a plurality of alignment screws each comprising: a body having a cylinder shape with a first end opposite a second end, wherein the first end comprises a male threaded portion, and the second end comprises a marking tip; mechanically fastening the plurality of alignment screws to an appliance by screwing the male threaded portions of the alignment screws into female threaded openings of the appliance; and pressing a side of the appliance against a surface such that the marking tips of the plurality of alignment screws create marks on the surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is an exploded perspective view of the present invention, taken along line 2-2 of FIG. 1;

FIG. 3 is a side elevation view of an embodiment of the present invention;

FIG. 4A is a side schematic view of an assembly process of an embodiment of the present invention;

FIG. 4B is a side schematic view of an assembly process of an embodiment of the present invention;

FIG. 4C is a side schematic view of an assembly process of an embodiment of the present invention; and

FIG. 4D is a side schematic view of an assembly process of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a tool to correctly locate positions for drilling mounting holes to mount a microwave or other appliance. The present invention may include a marking tip, with a threaded male screw portion, and a flange to align the tool perpendicular to the appliance. The present invention eliminates the need to measure from uncertain starting points since the marking tip marks the exact location to drill the mounting holes.

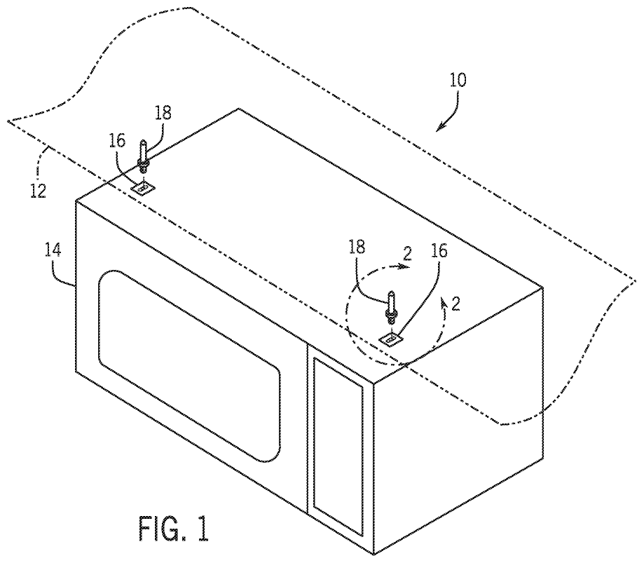

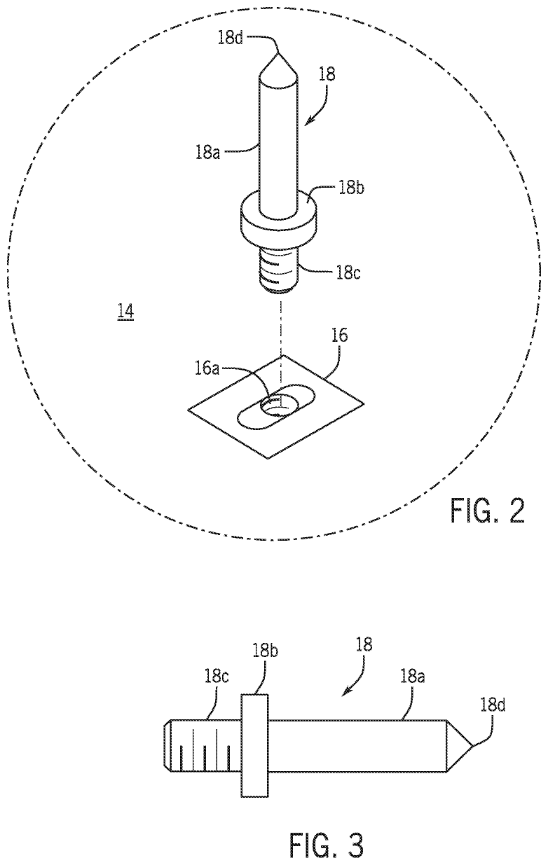

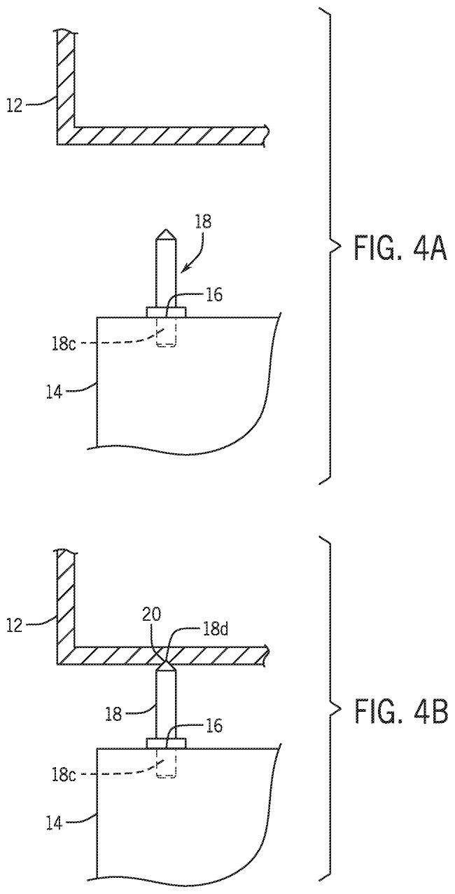

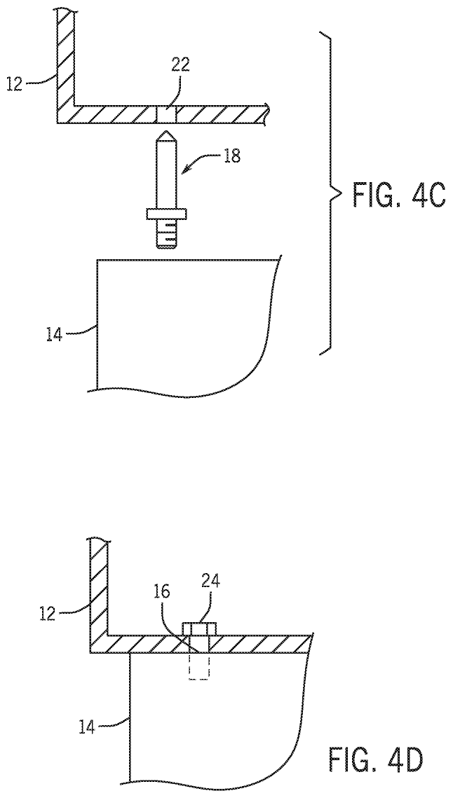

Referring to FIGS. 1 through 4, the present invention includes an alignment screw 18. The alignment screw 18 includes a body 18a having a cylinder shape with a first end opposite a second end. The first end includes a male threaded portion 18c. The second end includes a marking tip 18d configured to mark a surface 12 when the marking tip 18d is pushed against the surface 12. The alignment screws 18 may be made in one piece of cold roll steel, aluminum, or plastic injection molded.

In certain embodiments, the marking tip 18d includes a pointed end. In such embodiments, the marking tip 18d includes a cone shape having the pointed end. When using the marking tip 18d with the pointed end, the alignment screws 10 may be applied against the surface 12 and produce a detent 20. The marking tip 18d is not limited to a pointed end, and may include a marker, crayon, pencil, pen, or other marking device.

The present invention may further include a flange 18b. The flange 18b may be a disc shape and extends radially from the body 18a. The flange 18b divides the body between the male threaded portion 18c and a non-threaded portion. The flange 18b includes a bottom surface that is perpendicular to a longitudinal axis of the body 18a. Therefore, the flange 18b guides the alignment screw 18 to be perpendicular relative to the appliance 14 when secured to the appliance 14.

The present invention further includes a method of providing alignment marks 10. The method 10 includes providing a plurality of the alignment screws 18 described above. Mechanically fasten the plurality of alignment screws 18 to an appliance 14 by screwing the male threaded portions 18c of the alignment screws into female threaded openings 16a of mounting brackets 16 of the appliance 14. Lift the appliance 14 upward and press a side of the appliance against a surface 12 such that the marking tips 18d of the plurality of alignment screws create marks, such as detents 20, on the surface 12. Drill holes 22 at each of the marks on the surface 12. Remove the plurality of alignment screws 18 from the appliance 14. Place the side of the appliance 14 against the surface 12, run mounting screws 24 through the holes 22, and screw the mounting screws 24 into the female threaded openings 16a of the appliance 14. The surface 12 may be a cabinet base and the appliance 14 may be a microwave. The alignment screws 18 eliminates the need to measure and locate positions for mounting screw holes 22.

It should be understood, of course, that the foregoing relates to exemplary embodiments of the invention and that modifications may be made without departing from the spirit and scope of the invention as set forth in the following claims.

What is claimed is:

1. An alignment screw comprising:
a body having a cylinder shape with a first end opposite a second end, wherein
the first end comprises a male threaded portion, and
the second end comprises a marking tip configured to mark a surface when the marking tip is pushed against the surface.

2. The alignment screw of claim 1, wherein the marking tip comprises a pointed end.

3. The alignment screw of claim 2, wherein the marking tip comprises a cone shape having the pointed end.

4. The alignment screw of claim 1, further comprising a flange extending radially from the body, wherein the flange divides the body between the male threaded portion and a non-threaded portion.

5. A method of providing alignment marks comprising steps of:
providing a plurality of alignment screws each comprising:
a body having a cylinder shape with a first end opposite a second end, wherein
the first end comprises a male threaded portion, and
the second end comprises a marking tip;
mechanically fastening the plurality of alignment screws to an appliance by screwing the male threaded portions of the alignment screws into female threaded openings of the appliance; and
pressing a side of the appliance against a surface such that the marking tips of the plurality of alignment screws create marks on the surface.

6. The method of claim 5, further comprising a step of:
drilling holes at each of the marks on the surface.

7. The method of claim 6, further comprising steps of:
removing the plurality of alignment screws from the appliance;
placing the side of the appliance against the surface; and
running mounting screws through the holes and screwing the mounting screws into the female threaded openings of the appliance.

8. The method of claim 5, wherein the marking tip comprises a pointed end.

9. The method of claim 8, wherein the marking tip comprises a cone shape having the pointed end.

10. The method of claim 5, further comprising a flange extending radially from the body, wherein the flange divides the body between the male threaded portion and a non-threaded portion.
